(19) United States
(12) Patent Application Publication
(10) Pub. No.: US 2025/0355099 A1
(43) Pub. Date: Nov. 20, 2025

(54) METHOD FOR CALIBRATION OF A SENSOR SYSTEM, STORAGE MEDIUM, SENSOR SYSTEM, AND TRANSPORT SYSTEM

(71) Applicant: SICK AG, Waldkirch (DE)

(72) Inventors: Patrick SCHOEN, Waldkirch (DE); Stephan WALTER, Elzach-Yach (DE)

(21) Appl. No.: 19/211,075

(22) Filed: May 16, 2025

(30) Foreign Application Priority Data
May 17, 2024 (EP) 24176717.7

(51) Int. Cl. G01S 7/497; G01S 17/88

(52) U.S. Cl. CPC G01S 7/497; G01S 17/88; B65G 2203/025; B65G 2203/042

(57) ABSTRACT

The present invention relates to a method for calibrating a sensor system comprising at least one spatial sensor and at least one speed sensor, in particular for calibrating a volume measurement system, for conveying devices. According to the invention, a corresponding method comprises at least the following steps: recording reference data with an empty detection zone of the at least one spatial sensor by means of the at least one spatial sensor; conveying a cuboid test object in two different relative positions and orientations through the detection zone of the at least one spatial sensor and recording corresponding measurement data; determining an absolute orientation of the at least one spatial sensor and/or a correspondence factor for the speed sensor based on the determined reference data and measurement data using a mathematical optimization algorithm. Furthermore, the present invention also relates to sensor systems and conveying systems configured to carry out this method and to a computer-readable storage medium on which corresponding instructions are stored.

The present invention relates to a method, in particular a computer-aided or a computer-implemented method, for calibrating a sensor system, in particular a volume measurement system, for conveying devices, to a storage medium comprising corresponding computer-executable instructions, to a corresponding sensor system, in particular in the form of a volume measurement system, and to a corresponding conveying system.

Conventionally, the calibration of corresponding sensor systems takes place manually in a static state of the conveying device. Specifically, this means that each provided sensor is calibrated individually. In the case of spatial sensors, calibration is here understood as the determination of the position and orientation of the respective spatial sensor. This, for example, takes place in that, for each provided spatial sensor, the coordinates of three (linearly independent) points within the sensor plane (spanned by the signals emitted by the sensor; for example, in the form of laser beams in the case of LiDAR sensors) are measured by hand. In this respect, two of the points are typically located at the respective conveying device and one point at a test object on a conveying surface of the conveying system. Based on these coordinates, the six parameters that define the position and orientation of the respective spatial sensor are determined mathematically. The determination of a correspondence factor for a provided speed sensor usually takes place subsequent to the calibration of the spatial sensors. For this purpose, a very long test object with a known length is typically conveyed through the detection zone of the spatial sensors and, form this, the corresponding correspondence factor is calculated that puts the signal of the speed sensor in relation with a corresponding speed of the test object.

This static calibration by hand is not only very time-consuming, but is also prone to errors. In addition, the different sensors can only be set up individually and not together. Furthermore, errors in the manual calibration of the provided spatial sensors also lead to errors in the calibration of the speed sensor. As a result, the calibration may possibly have to be performed or corrected multiple times. The necessary accuracy of the calibration and ultimately of the calibrated sensor system or measurement system can thus only be achieved with difficulty in practice.

It is therefore the underlying object of the invention to provide a possibility of calibrating corresponding sensor systems that is faster and less error-prone than the conventional manual calibration.

This object is satisfied by a method according to claim 1. Advantageous further developments and uses of said method are set forth in the dependent claims.

According to the invention, a method for calibrating a sensor system comprising at least one spatial sensor and at least one speed sensor, in particular for calibrating a volume measurement system, for conveying devices comprises at least the following steps: recording reference data with an empty detection zone of the at least one spatial sensor by means of the at least one spatial sensor; conveying a cuboid test object in a first relative position and orientation through the detection zone of the at least one spatial sensor and recording a first set of corresponding measurement data by means of the at least one spatial sensor and the at least one speed sensor; conveying the cuboid test object in a second relative position and orientation through the detection zone of the at least one spatial sensor and recording a second set of corresponding measurement data by means of the at least one spatial sensor and the at least one speed sensor; determining the different positions and orientations of at least three sides of the test object relative to the at least one spatial sensor using the two sets of measurement data against the background of the reference data; determining a relative orientation of the at least one spatial sensor relative to said three sides of the cuboid test object; determining an absolute orientation of the at least one spatial sensor and/or a correspondence factor for the speed sensor based on the determined positions and orientations of the at least three sides of the test object from the at least two measurement sequences using a mathematical optimization algorithm.

An “empty” detection zone is defined in the present case as a detection zone without a test object in the detection zone so that the reference data effectively represent a “background image” of the conveying device. The position of a corresponding spatial sensor can be determined, for example, in the form of three polar coordinates (or three Cartesian coordinates), while the orientation of a corresponding spatial sensor is e.g. determined in the form of three Euler angles. In the present case, the position of the test object is in particular understood as the lateral positioning of the test object transverse to the conveying direction of the conveying device on a corresponding conveying surface. Specifically, it is thus irrelevant for the definition of two different positions whether the test object is placed on the conveying device closer or further away from the detection zone of the at least one spatial sensor in the conveying direction. The only relevant factor is the height at which the test object passes through the respective detection zone. In the case of a conveyor belt, the orientation of the test object, for example, comprises both the selection of that side of the test object on which it stands on a corresponding conveying surface and the rotational orientation of the test object around a normal of the conveying surface. The rotational orientation of the test object around the normal of the conveying surface is, for example, determined by the smallest angle of the different surface normals of the sides of the test object relative to the conveying direction. The position and orientation of sides of the test object can, for example, be determined by their surface normals and by a respective corresponding, possibly common, suspension point. To determine the absolute orientation of the at least one spatial sensor and/or the correspondence factor, the recorded reference data and measurement data are fed into a suitable model that is based on the assumption that the test object is a cuboid test object. In the present case, a test object that has three different side lengths is in particular understood as cuboid. The finally determined absolute orientation of the at least one spatial sensor and/or the correspondence factor ultimately results from the best compatibility of the measurement data of the different measurement sequences in the case of an assumed uniform orientation of the spatial sensors and/or in the case of a correspondence factor for the speed sensor for the different measurement sequences that is assumed to be fixed.

The thereby defined dynamic method for calibrating the sensor system is largely automated and does not require time-consuming and error-prone manual measurements by a user. It can thus be carried out comparatively quickly and is less prone to errors. In particular, the deployment of specialist personnel to set up the sensor system is thus no longer necessary.

The at least one spatial sensor preferably comprises at least two, in particular two or three, differently positioned and preferably also differently oriented spatial sensors. The detection zones of said spatial sensors intersect and/or overlap with one another in a preferred manner.

A plurality of spatial sensors enable the comprehensive spatial mapping of objects that are moved through a detection zone of said spatial sensors. This ultimately enables a comprehensive analysis of the respective objects. An intersection and/or an overlapping of the detection zones of the plurality of spatial sensors facilitates the combined evaluation of the measurement data of the individual spatial sensors.

The at least one spatial sensor, in particular each of the provided spatial sensors, is preferably oriented at an angle of between 45° and 90°, for example at an angle of 60°, to a conveying surface of the conveying device, on which conveying surface the test object is moved through the detection zone of the at least one spatial sensor.

In illustrative terms, the at least one spatial sensor in particular looks at objects, which pass through the sensor region of the respective spatial sensor, obliquely from above and from the front (opposite to a conveying direction). This enables the reliable mapping of at least three sides of cuboid objects, which pass through the respective sensor region, by means of every single one of the spatial sensors provided. This not only allows the reduction of the number of spatial sensors to be provided for the comprehensive mapping of corresponding objects, but, due to redundancy effects, also allows a more reliable and precise determination of the positions and/or orientations of the provided spatial sensors.

Said at least one spatial sensor is preferably one or more LiDAR sensors.

LiDAR sensors enable a particularly accurate and reliable mapping of the sensor region.

The speed sensor is preferably an encoder that is coupled to a movable component of the conveying device.

Accordingly, encoders are particularly compact and are regularly provided in corresponding conveying devices anyway, for example in their drives.

The different positions and orientations of three sides of the test object that meet at a common corner of the test object are preferably determined.

This enables a relatively simple yet comprehensive determination of the respective positions and orientations of the test object.

The determination of the positions and orientations of these three sides preferably comprises identifying the surface normals of these three sides and identifying the relative position of the common corner.

With an appropriate selection of the three sides of the test object, these features are completely sufficient for a comprehensive determination of the positions and orientations of the test object and are easy to process.

The common corner referred to preferably lies above a conveying plane spanned by the conveying surface.

In addition to said three sides, this also makes it relatively easy to determine the position and orientation of a fourth side of the test object in the form of that side with which the test object lies on a conveying surface of the conveying device and to take this into account in the method for calibration. For example, the further sides can be used to verify and/or correct the recognized positioning of the object.

The method preferably comprises requesting and/or entering the side lengths of the cuboid test object.

These side lengths are preferably fed into the respective model as further reference values and thus in particular enable the recognition of errors in the measurement data. If the side lengths of the respective test object determined from the measurement data do not lie within corresponding tolerance ranges of these reference values, something has obviously gone wrong during the determination of the measurement data or their evaluation. The entered side lengths in this respect only serve as orientation values, while exact values for the side lengths can be determined from the measurement data of the different measurement sequences. Inaccuracies in a manual measurement of the side lengths thus have no direct influence on the result of the calibration itself.

The method preferably further comprises conveying the cuboid test object in a third relative position and orientation through the detection zone of the at least one spatial sensor and recording and evaluating a third set of corresponding measurement data. In this respect, the vertical orientation of all three relative positions and orientations are preferably different from one another and the method comprises determining and/or correcting the side lengths of the cuboid test object using the three sets of measurement data for the three different vertical orientations of the cuboid test object.

In illustrative terms, the wording “vertical orientation” is understood as the specific choice of that wall on which the test object is placed, or which of the three side lengths of the test object acts as the height of the test object. In the case of an assumed cuboid test object with three different side lengths, there are six sides, of which a respective two are disposed opposite one another pair-wise and are formed identically to one another. The test object is in a first vertical orientation when the test object stands on one of the two sides of a first pair of identical sides disposed opposite one another pair-wise. The test object is in a second vertical orientation when the test object stands on one of the two sides of a second pair of identical sides disposed opposite one another pair-wise. Finally, the test object is in a third vertical orientation when the test object stands on one of the two sides of the third pair of identical sides disposed opposite one another pair-wise. Thus, a different height of the test object results for each of the three measurement sequences, wherein each of these three heights corresponds to a side length of the test object. The totality of the measurement data of these three measurement sequences enables a particularly simple yet reliable and accurate determination of the different side lengths of the test object, which considerably facilitates the calibration of the spatial sensors and/or the speed sensor.

The method preferably further comprises conveying the cuboid test object in a fourth relative position and orientation through the detection zone of the at least one spatial sensor and recording a fourth set of corresponding measurement data by means of the at least one spatial sensor and the at least one speed sensor. An absolute position of the at least one spatial sensor is determined relative to a fixed origin on the basis of the totality of the four sets of measurement data, taking into account the reference data, using a or the mathematical optimization algorithm.

The determination of the position of the provided spatial sensors in particular takes place together with the determination of the orientation of the provided spatial sensors using a single comprehensive model and in the course of a joint optimization process or by means of a joint mathematical optimization algorithm.

In the following, it is described in detail how the optimization problem can be understood and solved, i.e. one possible mode of operation of the optimization algorithm is described:

Specifically, a dynamic calibration wizard can be provided to simultaneously calculate different parameters of provided spatial sensors and an associated speed sensor. For example, the user is offered a web interface that guides the user through several steps in the form of a wizard. During the installation, the test object, in particular in the form of a test box, is moved at a preferably constant speed through the monitored zone of the sensor system in four different positions and orientations with the aid of a conveying device. The calibration wizard described below automatically determines all the required parameters from the measured planes of extent of the side surfaces of the test box using a mathematical optimization algorithm. For this purpose, the side surfaces of the test box must be as perpendicular to one another as possible.

The calibration wizard can be configured as follows:

### 1. Initial Situation

A volume measurement system, for example, comprises a plurality of LiDAR sensors that are positioned above a conveying system. A speed sensor, in particular in the form of an encoder having a measuring wheel, provides motion feedback and precise position information of the conveying system.

The dynamic calibration wizard aims to estimate the position t_{S}=(x,y,z) and the orientation (parameterized via three Euler angles ∝, β, γ) of each of the sensors. In addition to these six sensor coordinates, it likewise calculates a correspondence factor η that converts the signal of the encoder into precise position information.

A point in the sensor coordinates is given in the form of polar coordinates d,θ. After transforming them into Cartesian coordinates, each point is defined as:

$${p}^{′} := ( {e}^{′} , d cos ( θ ) , - d sin ( θ ) ) .$$

Here, p′ refers to the original frame of the Cartesian sensor coordinates and e′ refers to the encoder incremental value. Each point in the sensor coordinates can be converted into world coordinates via:

$$p = {Ap}^{′} + {t}_{S} ,$$

where A corresponds to the following affine transformation:

$$A = [ {[ η , 0 , 0 ]}^{T} , {R}_{x} , {R}_{y} ]$$

and R corresponds to the following rotation matrix:

$$R ( α , β , γ ) = [ {R}_{x} , {R}_{y} , {R}_{z} ]$$

parameterized by the three Euler angles.

### 2. Initiation

To initiate the calibration process, measurement data are collected for an empty conveying device (i.e. without a test object or test box). This background information is subsequently used to separate relevant measurement points of the cuboid test object from the background. The user is prompted to enter the length, width and height (l, w, h) of the test box. This information is later used to estimate the spatial positions of the calibrated spatial sensors.

### 3. Mounting the Test Box in Four Different Positions and Orientations

A cuboid test object is positioned on the conveying device such that, when the test object passes the spatial sensors, each of the spatial sensors “sees” three sides of the test object. It is assumed that the test object is rotated about the z axis (the vertical in the present case) by an unknown angle ρ. The background information is used to separate a point cloud, which maps the test object, from the background.

Using a clustering algorithm in the normal set of the segmented point cloud and a standard algorithm for plane fitting, the three plane normals

$${n}_{1}^{′} , {n}_{2}^{′} , {n}_{3}^{′}$$

and the intersection point q_{S}′, where all three sides meet, are calculated.

The user receives instructions to place the test box on the conveying device in four different predefined positions and orientations and to allow the sensor system to pass. As soon as the test box has been picked up in the respective displayed position and orientation, the algorithm recognizes this and automatically displays instructions for the next position and orientation. The orientation of the spatial sensors is determined, in addition to other information, based on two different positions, in particular one on the left of the conveying device and one on the right of the conveying device. The orientation of the sensors indicates the direction in which the inner mirror wheel of the respective LiDAR sensors rotates. By mounting the test box in all three of its different heights (i.e. vertical orientations), it is later possible during the optimization to determine the exact dimensions of the test box and to eliminate errors or inaccuracies due to a manual measurement of the test box.

The wizard checks the recorded data and estimates whether the test object has been positioned in the respective correct position and orientation. If the wizard determines that the test object has been positioned in the wrong position or orientation, the user is prompted to verify this and to return to the corresponding step, if necessary.

### 4. Representation of a Rotation by Quaternions

The affine transformation

$$A = [ {[ η , 0 , 0 ]}^{T} , {R}_{x} , {R}_{y} ]$$

depends on the rotation matrix R that is parameterized by the Euler angles:

$$R = R ( α , γ , γ ) .$$

A representation by Euler angles leads to numerically unstable estimates. To obtain more stable estimates, the rotation is expressed by its corresponding four tuple quaternions q:

$$R = R ( q ) , q = ( {q}_{0} , {q}_{1} , {q}_{2} , {q}_{3} ) .$$

Similarly, a rotation about the z axis (i.e. about the vertical) can be expressed by:

$${R}_{z} = R ( u ) , u = ( {u}_{0} , {u}_{1} ) .$$

In this respect, it should be noted that the respective rotations each still only have three degrees of freedom or one degree of freedom after it is assumed that the quaternions are normalized.

Generally speaking, the optimization algorithm according to one embodiment uses an affine transformation and/or provides a rotation by quaternions.

### 5. Sensor Plane Equation

As already indicated above, points of the sensor coordinates are to be transformed into world coordinates using the following equation:

$$p = {Ap}^{′} + {t}_{s} .$$

Based on the above, planes must be transformed. Let it be assumed that

$${n}_{i}^{′}$$

refers to a plane normal in sensor coordinates and nᵢ to the corresponding plane normal in world coordinates. Both vectors are assumed to be normalized, i.e.

$$‖ {n}_{i}^{′} ‖ = ‖ {n}_{i} ‖ = 1.$$

Under the affine transformation, it applies that A^{T}ₙ_{ᵢ} is parallel to

$${n}_{i}^{′}$$

or:

$${A}^{T} {n}_{i} = {n}_{i}^{′} ‖ {A}^{T} {n}_{i} ‖ .$$

In the four passages from section 3, the test box is rotated about the z-axis (i.e. about the vertical) at a specific angle φ in each case. Let it be assumed that there is an angle φ at which the test box is rotated such that the two side walls of the test object, which are “seen” by a spatial sensor, are oriented to eₓ=e₀=(1,0,0) and e_{y}=e₁=(0,1,0), respectively. In this respect, the cover surface always points to e_{z}=e₂=(0,0,1).

The rotation is given by the rotation matrix R_{z}(φ). The following then applies to the plane normals of the test box:

$${A}^{T} {n}_{i} = {A}^{T} {R}_{z} ( φ ) {e}_{i} ∝ {n}_{i}^{′} , i = 0 , 1 , 2 ,$$

and thus

$${A}^{T} {R}_{z} ( φ ) {e}_{i} \times {n}_{i}^{′} = 0 , i = 0 , 1 , 2.$$

### 6. Constrained Minimization Problem

The sensor plane normals

$${n}_{i}^{k}$$

are preferable measured for each test run k=0,1,2,3. The rotation matrix, together with an assumed object rotation φ^{k} about the z-axis, is given by

$$R = R ( q ) = R ( {q}_{0} , {q}_{1} , {q}_{2} , {q}_{3} ) , {R}_{z} ( φ ) = {R}_{z} ( {u}^{k} ) = {R}_{z} ( {u}_{0}^{k} , {u}_{1}^{k} ) .$$

The rotation parameters q and u^{k}, together with the encoder resolution parameter η, are determined by solving the following nonlinear constrained minimization problem:

$${min}_{η , q , {u}^{k}} {\sum }_{k} {F}^{k} ( η , q , {u}^{k} ) ,$$

$$where$$

$${F}^{k} ( η , q , {u}^{k} ) = {\sum }_{i} {‖ {A}^{T} ( q ) {R}_{φ} ( {u}^{k} ) {e}_{i} \times {n}_{i}^{′} ‖}^{2} .$$

After the quaternions have been normalized, the following constraints apply:

$${f}_{1} ( q ) = {\sum }_{i = 1}^{4} {q}_{i}^{2} - 1 = 0 , {f}_{2} ( u ) = {\sum }_{i = 1}^{2} {( {u}_{i}^{k} )}^{2} - 1 = 0 .$$

This can be solved by standard numerical optimization techniques. One way to solve this is the Levenberg-Marquardt algorithm, wherein the constraint is introduced via a Lagrange multiplier.

With reference to the statements under point 1, it should be noted that this problem can also be solved without any constraints.

Specifically, it was found that the most practical approach for stable results is to solve the minimization problem iteratively, wherein the constraints are introduced via regularization expressions. In each step, a modified constrained minimization problem is solved by

$${F}_{ε}^{k} ( η , q , {u}^{k} ) = {F}^{k} ( η , q , {u}^{k} ) + \frac{1}{ε} {\vert {f}_{1} ( u ) \vert}^{2} + \frac{1}{ε} {\vert {f}_{2} ( u ) \vert}^{2}$$

with an ever decreasing regularization parameter ε. Each step represents an unconstrained minimization problem and can be solved using a Gauss-Newton iteration algorithm. An initial starting value for the optimization algorithm can be calculated using the following assumption:

$${A}^{T} {n}_{i} \approx κ {n}_{i}^{′} ,$$

where κ corresponds to an initial estimate of ∥A∥.

Generally speaking, the optimization algorithm according to one embodiment solves an optimization problem, wherein the optimization problem comprises a minimization problem, in particular a constrained minimization problem, that is solved iteratively.

### 7. Estimation of the Relative Spatial Positions Between Two Sensors

An approximate solution to the optimization problem gives an approximation to the affine transformation matrix A including the orientation of each of the sensors, indicated by their Euler angles α, β, γ together with the rotation angle φ of the test object during each passage. With knowledge of the orientation of the sensors, it is easy to determine which planes were “seen” by the sensors during the different passages. With this information, the respective object corner can be determined that corresponds to the intersection point q's of the three planes under consideration. The corresponding object corner can differ between the sensors. In general, in a sensor system having two sensor units, the object corner that is “seen” by the second sensor unit is disposed opposite that object corner which is “seen” by the first sensor unit. Assuming that two LiDAR sensors are provided, let r be the spatial relationship vector between the world coordinates of these two intersection points, that is:

q_{S,1}=q_{S,2}+r.

Using the dimensions of the test box and the estimated object rotation, the value of r can be easily calculated. Together with the above equation of the affine transformation, the relative spatial positioning of the two sensors under consideration can be determined.

### 9. Optional Downstream Optimization of the Dimensions of the Test Object

Via a downstream optimization step, it is possible to avoid uncertainties that possibly result from a manual measurement of the test box. Using the first optimization step, it is possible to find the parallel side surfaces and the cover surface (parallel to the conveying surface) of the test object in the four passages. With an appropriately supplemented optimization function F(η,qᵢ,uᵢ,t_{S},l,w,h), it is possible to optimize the values of the dimensioning of the test box together with the values of the orientation of the sensors.

### 10. Optional Static Measurement

A static measurement step can be used to determine the relative position of the sensor system in relation to other sensors (such as code readers, cameras or trigger sensors). This enables the determination of the absolute position of the sensor system in relation to a fictitious zero point.

### 11. Results

In a final step, the calibration wizard displays the calculated parameters to a user. In this respect, the user can be offered the option of setting and saving the calculated parameters directly for all the sensors.

The above statements show exemplary considerations for implementing the present invention. It should be noted that, insofar as they are independent of one another, they can each be used separately to further develop the basic idea of the present invention. In other words, the above statements are not to be understood as a coherent complex of a plurality of inseparably linked features, but rather as a collection of individual considerations or features for the particularly advantageous implementation of the present invention.

It should be noted here that the four relative positions and orientations of the test object are to differ from one another. However, certain similarities between them are not ruled out and even enable a simpler evaluation. For example, for two measurement sequences, the test object can be provided at a first position on the conveying surface to pass through the detection zone of the at least one spatial sensor in a first region and, for the other two measurement sequences, the test object can be provided at a second position on the conveying surface to pass through the detection zone of the at least one spatial sensor in a second region. For the respective pair-wise measurement sequences with the same position for the test object, it is then, however, necessary for the orientation of the test object to differ. In particular, at least one of the vertical orientation and the horizontal orientation of the test object in this respect differs between two corresponding measurement sequences. The horizontal orientation is here understood as the rotational orientation of the test object around a normal of the conveying surface.

Said four measurement sequences enable a comprehensive and precise calibration of the provided spatial sensors and also a particularly accurate determination of the correspondence factor of the speed sensor. The carrying out and consideration of more than four measurement sequences is also possible in order to obtain a more reliable calibration, but is also associated with a corresponding additional effort. It is also conceivable to perform one or more verification sequences by means of which it is checked whether the system calibrated in this way ultimately also works reliably and outputs plausible values. Preferably, the positions and orientations of the different measurement sequences of the test object through the detection zone in each case differ from one another by at least two, in particular exactly two, of the horizontal orientation, the vertical orientation and the horizontal position of the test object.

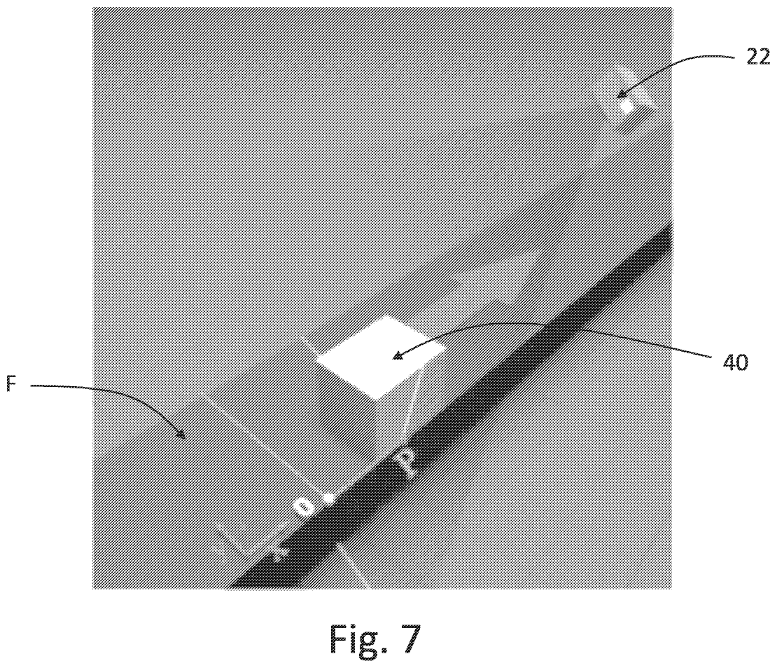

The horizontal orientation is here defined by the orientation of the test object relative to the conveying direction of the conveying device. The vertical orientation is defined by the choice of the side of the test object on which the test object is placed. The horizontal position of the test object is determined by the positioning of the test object transverse to the conveying direction of the conveying device. For example, reference is made to a Cartesian coordinate system whose origin lies on the conveying surface, whose x-axis lies on the conveying surface and indicates the conveying direction, whose y-axis lies on the conveying surface and extends transversely to the x-axis, and whose z-axis extends perpendicular to the conveying surface, as shown in FIG. 7. The horizontal orientation is then understood in illustrative terms as the rotational orientation of the test object about the z-axis, while the horizontal position indicates the position of the test object along the y-axis. The vertical orientation defines the height of the test object along the z-axis.

Due to this variation, it is possible to observe the test object in different positions and orientations when it passes through the detection zone of the at least one spatial sensor and to reliably and accurately determine the specific position and orientation of the at least one spatial sensor or the plurality of spatial sensors from the corresponding measurement data.

The vertical positioning of the cuboid test object is preferably defined by a conveying surface of the conveying device on which one side of the cuboid test object lies and is identical for all the measurement sequences.

Specifically, a variation of the vertical orientation of the test object therefore takes place by varying that side length which acts as the height. However, the test object is placed on the same conveying surface for each measurement sequence and thus has the same vertical positioning (i.e. the positioning along the z-axis in FIG. 7) for each measurement sequence. The degree of freedom of the vertical positioning is thus eliminated, which considerably facilitates the evaluation of the measurement data and already allows a small number of measurement sequences to be sufficient for a comprehensive calibration of the sensor system.

Preferably, the method further comprises positioning the cuboid test object in the detection zone of the at least one spatial sensor and recording associated static measurement data, determining the relative position of the at least one spatial sensor relative to at least one further sensor, in particular in the form of a reading device, a camera or another type of trigger sensor, and determining an absolute position of the at least one further sensor from the determined relative position of the at least one further sensor relative to the at least one spatial sensor.

Due to this “static” calibration of further sensors, it is possible in a particularly simple manner to integrate further sensors into the sensor system and to calibrate them without having to repeat the above-described method in its entirety. Examples of further sensors are reading devices for coding, cameras or trigger sensors. It is hereby also possible to determine the absolute position of the entire system with respect to a selected zero point, preferably at the conveyor belt and given, for example, by a light barrier.

Preferably, the method further comprises performing a plausibility test on the recorded measurement data and/or the determined features of the test object and/or of the at least one spatial sensor and/or of the speed sensor, and outputting an error message to a user if discrepancies are recognized.

Such a plausibility test can, for example, take place in the form of a comparison of calculated side lengths of the test object with reference values entered by a user for this purpose. Determined positions and orientations of the provided spatial sensors can also be compared with spatial conditions. If it is, for example, revealed for the calculated orientation of a spatial sensor that it is not oriented to the conveying surface at all, an error may be deduced therefrom. An error can also be deduced if the calculated position and/or orientation deviates too much from a target position and/or target orientation predefined for the device. Too large discrepancies of the optimized position and/or orientation or correspondence factors from corresponding values from individual measurement sequences can also indicate an error in one of these measurement sequences. The output of a corresponding error message enables a user to make appropriate corrections manually and/or, for example, to repeat one of the performed measurement sequences (or the entire method for calibration). It is also possible to give a user specific instructions or suggestions for positioning and/or orienting the test object for the different measurement sequences, in particular depending on measurement data from previous measurement sequences. Deviations from corresponding instructions or suggestions can be determined and can influence subsequent instructions or suggestions and/or can result in a message to the user.

Furthermore, the present invention also relates to a computer-readable storage medium on which instructions are stored that cause a suitable sensor system, in particular a corresponding volume measurement system, for conveying devices to carry out the method described above and/or to guide a user through a corresponding method.

The present invention also relates to a sensor system, in particular a volume measurement system, that is configured to carry out the method described above. Finally, the present invention also relates to a conveying system comprising a conveying device for conveying objects and the sensor system described above, in particular in the form of a volume measurement system, said sensor system being oriented to the conveying device and being configured to analyze objects that are conveyed by the conveying device.

The statements on the method according to the invention apply accordingly to the storage medium according to the invention, the sensor system according to the invention and the conveying system according to the invention; this in particular applies with respect to advantages and embodiments. It is also understood that all the features mentioned herein can be combined with one another, unless explicitly stated otherwise.

The invention will be described purely by way of example with reference to the drawings in the following. There are shown:

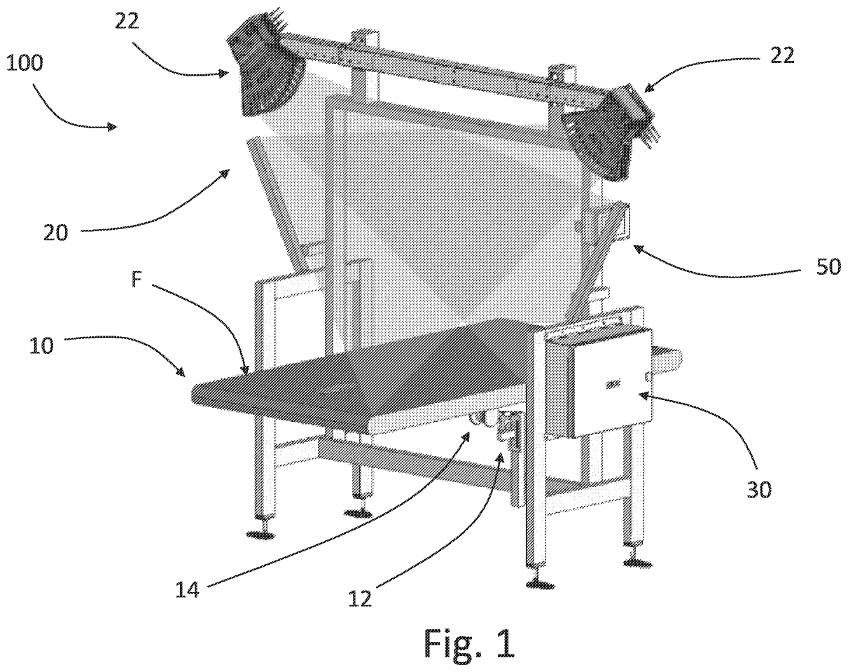

FIG. 1 a schematic perspective view of a section of an exemplary conveying system comprising a sensor system according to the present invention;

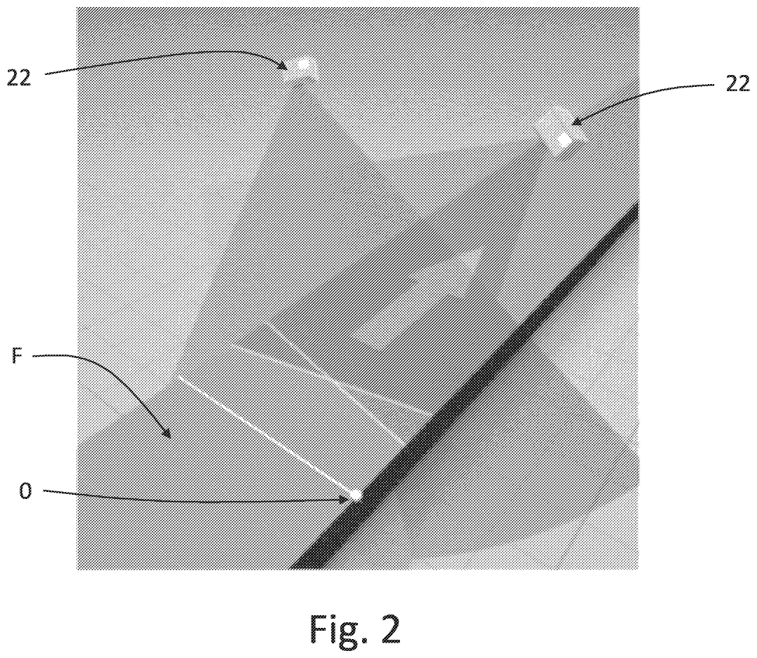

FIG. 2 schematically, a first method step of an exemplary method according to the invention; and

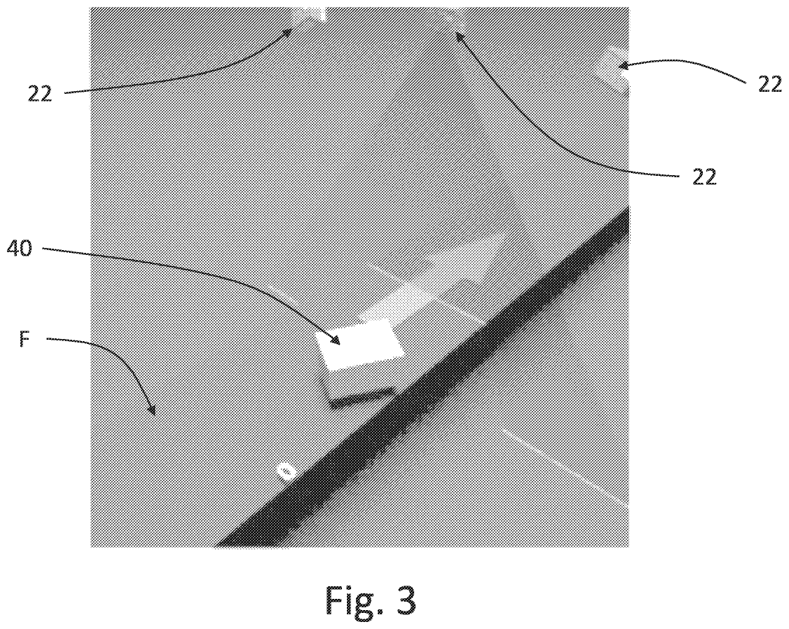

FIG. 3 schematically, a second method step of an exemplary method according to the invention;

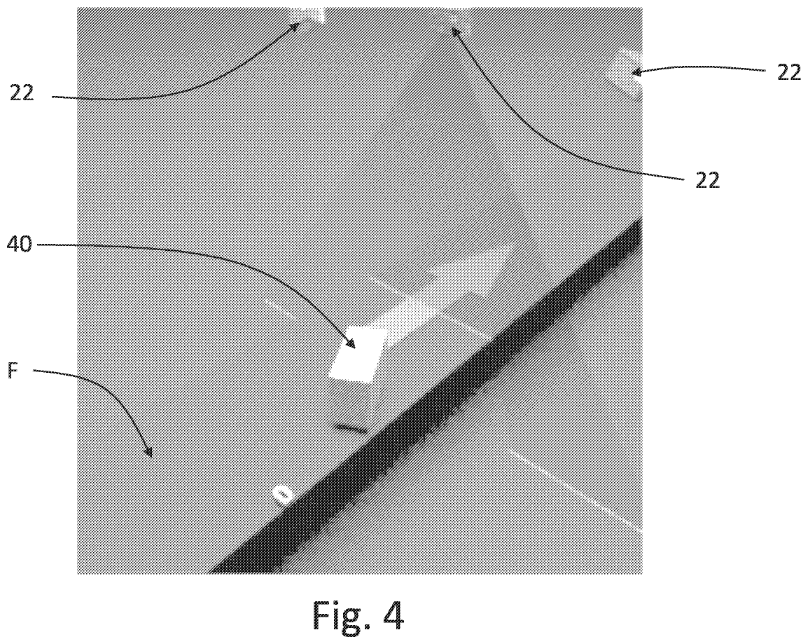

FIG. 4 schematically, a third method step of an exemplary method according to the invention;

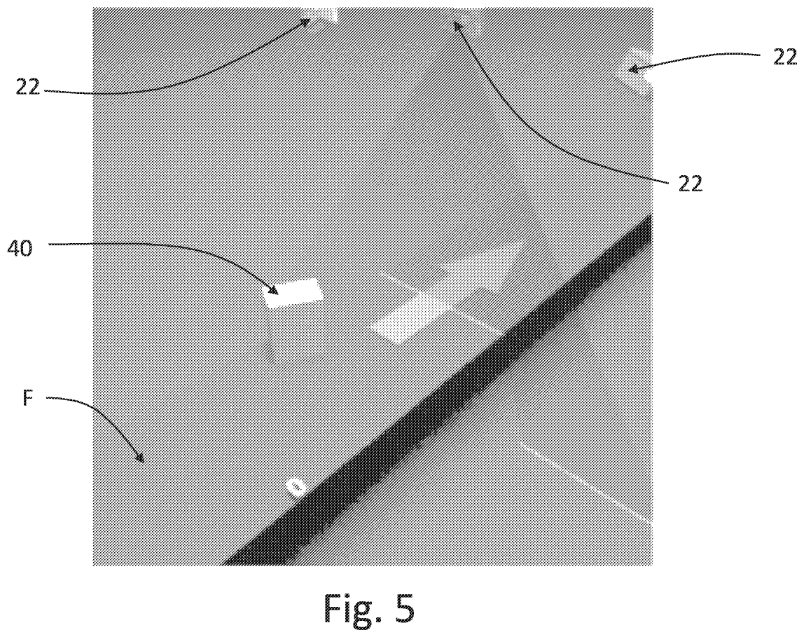

FIG. 5 schematically, a fourth method step of an exemplary method according to the invention;

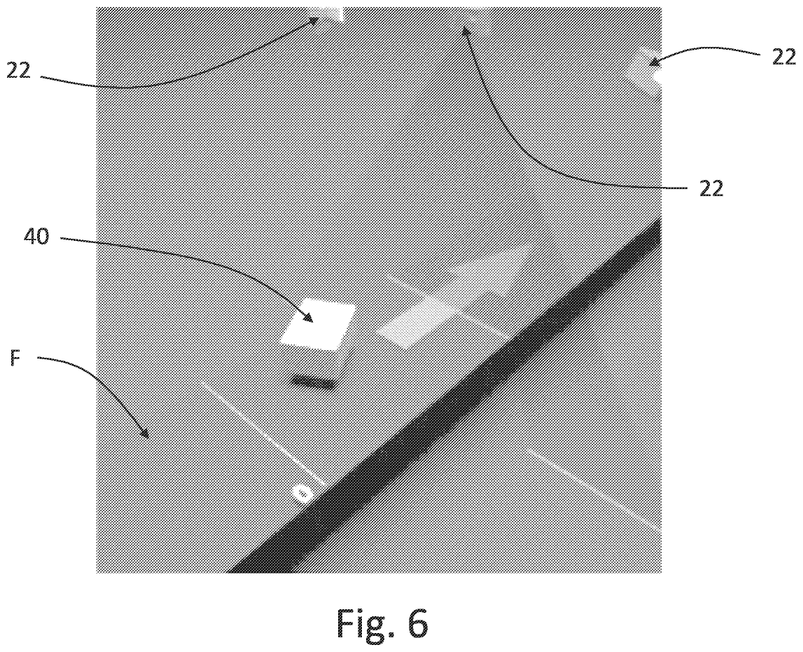

FIG. 6 schematically, a fifth method step of an exemplary method according to the invention; and

FIG. 7 schematically, an optional sixth method step of an exemplary method according to the invention.

FIG. 1 schematically shows the design of a conveying system 100 comprising a conveying device 10 and a sensor system 20. The conveying device 10 shown here is configured in the form of a conveyor belt whose surface defines a conveying surface F on which the conveying device 10 can convey different objects 40 along a conveying direction (in this case from the front left to the rear right in the image; see also the arrows in FIGS. 2 to 7). In the embodiment shown, the sensor system 20 comprises two spatial sensors 22 in the form of LiDAR sensors that are oriented to the conveying surface F. A speed sensor 14 is configured as an encoder and is integrated into the drive 12 of the conveying device 10.

Both the two spatial sensors 22 and the speed sensor 14 are coupled to a common computing unit 30. Said computing unit 30 is configured to receive and evaluate measurement signals from the two spatial sensors 22 and the speed sensor 14. Specifically, the computing unit 30 is, for example, provided to determine the volume of an object 40, using the measurement signals of the two spatial sensors 22 and the speed sensor 14, that was moved by the conveying device 10 along the conveying direction through the detection zone of the spatial sensors 22. For this purpose, it is, however, necessary for the computing unit 30 to have information on the position and orientation of the spatial sensors 22 provided and information on a correspondence factor of the speed sensor 14. According to the invention, this information is no longer determined by hand and manually stored in the computing unit 30 (or its memory), but is determined via a specific method for calibration.

An example of a corresponding method is described with reference to FIGS. 2 to 6 in the following. However, it should be noted here that the sequence of the individual method steps in which the reference data and/or the measurement data are generated can be varied as desired. For example, it is possible to start with the measurement in FIG. 5 and to allow it to be followed by the reference measurement in FIG. 2, while the further measurements of FIGS. 3, 4 and 6 follow the reference measurement. It is only crucial that all the provided reference data and/or measurement data are available for the final calibration of the sensor system 20.

Whether the sensor system 20 in this respect comprises one spatial sensor (cf. FIG. 7), two spatial sensors 22 (cf. FIGS. 1 and 2) or three spatial sensors 22 (cf. FIGS. 3 to 6), is essentially irrelevant. However, a plurality of spatial sensors 22 allows a more comprehensive mapping of objects 40 on the conveying device 10.

The aim of the method described in the following is to determine the spatial position and orientation of the provided spatial sensors 22 and the correspondence factor of the speed sensor 12 in order to calibrate the sensor system 20. In the present example, the fixed point 0 at a right margin of the conveying surface F serves as the origin. The x-axis extends parallel to the conveying direction along the conveying surface F. The y-axis extends transversely to the conveying direction along the conveying surface F. The z-axis extends upwardly perpendicular to the conveying surface F (cf. the coordinate system in FIG. 7). The correspondence factor to be determined indicates the relationship between the measurement signal of the encoder 14 and a movement of an object 40 placed on the conveying surface F or of the conveying surface F along the conveying direction. Starting from a known initial position of the object 40, using this correspondence factor, the scope and possibly the direction (i.e. forwards or backwards) of a movement of the object 40 along the conveying direction, i.e. along the x-axis, can be determined from a measurement signal of the encoder 40. The positioning of the object 40 along the y-axis on the conveying surface F defines the essential aspect of the horizontal position of the object 40. A change in this vertical position on the conveying surface F may generally not change within a single measurement sequence. The same applies to the vertical position of the object 40 that in the present example is determined by the height of the conveying surface F and is the same for all the measurement sequences.

According to FIG. 2, the method presented by way of example starts with the recording of reference data by the spatial sensors 22 when the conveying device is empty, i.e. without a test object 40 within the detection zone of the spatial sensors 22. Specifically, an image of the detection zone of the spatial sensors 22 as a reference image for a subsequent identification of the test object 40 within the detection zone is thus made possible, for example, by forming a difference between the generated reference image and subsequent measurement images.

A query can then be made in which a user can store the rough dimensions of the test object 40 to be subsequently used in the computing unit 30. Such dimensions can later serve for the verification and evaluation of the further measurements. However, this step is not essential.

In the following, one and the same test object 40 is placed on the conveying surface F of the conveying unit 10 in four different variants and is moved by the conveying unit 10 through the detection zone of the spatial sensors 22. On each passage, the computing unit 30 generates a corresponding set of measurement data from the signals of the spatial sensors 22 and the speed sensor 14.

The test object 40 is preferably formed with three different side lengths, i.e. a length, a width and a height, that are different from one another.

According to FIG. 3, the test object 40 is moved for a first measurement sequence in a first position (to the right on the conveying surface F) in a first orientation (lying flat so that the height of the test object, for example, extends along the z-axis and at an angle of approximately +30 degrees relative to the conveying direction) through the detection zone of the spatial sensors 22.

According to FIG. 4, the test object 40 is moved for a second measurement sequence substantially in the first position (to the right on the conveying surface F) in a second orientation (laterally so that the width of the test object 40, for example, extends along the z-axis and at an angle of approximately −30 degrees relative to the conveying direction) through the detection zone of the spatial sensors 22.

According to FIG. 5, the test object 40 is moved for a third measurement sequence in a second position (to the left on the conveying surface F) in a third orientation (upright so that the length of the test object 40, for example, extends along the z-axis and at an angle of approximately +30 degrees relative to the conveying direction) through the detection zone of the spatial sensors 22.

According to FIG. 6, the test object 40 is moved for a fourth measurement sequence substantially in the second position (to the left on the conveying surface F) in a fourth orientation (flat as in FIG. 3, but at an angle of approximately −30 degrees relative to the conveying direction) through the detection zone of the spatial sensors 22.

In this respect, the spatial sensors 22 are each oriented at an angle of 45° to 90°, for example of 60°, to the conveying surface F such that, on the passage of the test object, each spatial sensor 22 “sees” or scans at least two, but preferably three sides of the test object 40. To ensure this, the dimensions for the test object 40 and/or the positions and orientations of the test object 40 can be specifically selected or at least roughly predefined for the different measurement sequences.

The computing unit 30 is configured to generate a virtual image of the test object 40 from the four sets of measurement data of the four measurement sequences, assuming a cuboid test object 40, with the aid of a mathematical optimization algorithm and against the background of the reference data, and to determine an absolute position and orientation of the spatial sensors 22 relative to the fictitious origin 0. In this respect, it is also simultaneously possible to determine the correspondence factor of the speed sensor 14 by comparing the measurement data of the spatial sensors 22 with the measurement data of the speed sensor 14.

It should be noted here that just two corresponding measurement sequences are sufficient to determine the orientation of the spatial sensors 22 and/or the correspondence factor of the speed sensor 14.

Specifically, to determine the position and/or orientation of each of the spatial sensors 22, the normal vectors of three different sides of the test object 40 and the location of a common corner of these three sides are determined from the measurement data. With reference to FIG. 3, the surface normals of the right front short side, the left front long side and the large upper side of the test object, as well as the location at which the front upper corner of the test object 40 penetrates the detection zone of the central spatial sensor 22, would therefore be determined. This takes place for each provided spatial sensor 22 for each individual measurement sequence.

If the test object 40 was measured in all three possible vertical orientations, the dimensions of the test object 40 can be directly deduced from the z-values of the respective upper corner of the measurement sequences.

From the recorded reference data and measurement data of the different measurement sequences, different models for the positions and orientation and/or for the correspondence factor are run through and optimized by means of a mathematical optimization algorithm in order to finally deduce the actual positioning and orientation and/or the actual correspondence factor.

The mathematical optimization algorithm can in this respect make use of simple numerical optimization techniques or can be specially trained (in particular by means of machine learning).

With regard to FIG. 7, in addition to the above statements, it is pointed out that, after an appropriate calibration, it is possible to determine the relative position of the spatial sensors 22 relative to a further provided sensor 50, for example in the form of a reading device for codes, a camera or a trigger sensor, by means of a simple static measurement sequence (i.e. with the test object 40 motionless). This enables a fast, simple and error-free determination of the position P of the further sensor 50.

The results for calculating the position and orientation of the spatial sensors 22 and/or the correspondence factor of the speed sensor 14, possibly together with the determined dimensions of the test object 40, can finally be displayed to a user to be viewed by the user again and to be subsequently stored in the computing unit 30, provided that no inconsistencies can be recognized here. It is also possible to have the computing unit 30 carry out a plausibility test independently and, depending on the result of said plausibility test, to issue an error message or to complete the calibration by adopting the determined values.

It should be noted that a system calibrated in this way need not be limited in its operation to the analysis of cuboid objects per se, but can analyze differently shaped objects, for example with respect to their volume. In principle, it would also be conceivable to implement variants of the present invention in which different test objects are measured and/or non-square test objects can be used. It should be noted that such variants may fall within the scope of protection of the claims as equivalent to the explicitly claimed embodiment.

### REFERENCE NUMERAL LIST

0 fictitious origin
10 conveying device
12 drive
14 speed sensor/encoder
20 sensor system
22 spatial sensor/LiDAR sensor
30 computing unit
40 object/test object
50 further sensor
100 conveying system
F conveying surface
P fictitious position of the further sensor

1-15. (canceled)

16. A method for calibrating a sensor system comprising at least one spatial sensor and at least one speed sensor for conveying devices, wherein the method comprises at least the following steps:
recording reference data with an empty detection zone of the spatial sensor by means of the at least one spatial sensor;
conveying a cuboid test object in a first relative position and orientation through the detection zone of the at least one spatial sensor and recording a first set of corresponding measurement data by means of the at least one spatial sensor and the at least one speed sensor;
conveying the cuboid test object in a second relative position and orientation through the detection zone of the at least one spatial sensor and recording a second set of corresponding measurement data by means of the at least one spatial sensor and the at least one speed sensor;
determining the different positions and orientations of at least three sides of the test object relative to the at least one spatial sensor using the two sets of measurement data against the background of the reference data;
determining a relative orientation of the at least one spatial sensor relative to said three sides of the cuboid test object;
determining an absolute orientation of the at least one spatial sensor and/or a correspondence factor for the speed sensor based on the determined positions and orientations of the at least three sides of the test object from the at least two measurement sequences using a mathematical optimization algorithm.

17. The method according to claim 16,
wherein the at least one spatial sensor comprises at least two differently positioned spatial sensors.

18. The method according to claim 16,
wherein the at least one spatial sensor is oriented at an angle of between 45° and 90° to a conveying surface of the conveying device, on which conveying surface the test object is moved through the detection zone of the at least one spatial sensor.

19. The method according to claim 16,
wherein said at least one spatial sensor is one or more LiDAR sensors, and/or wherein the speed sensor is an encoder that is coupled to a movable component of the conveying device.

20. The method according to claim 16,
wherein the different positions and orientations of three sides of the test object that meet at a common corner of the test object are determined; and
wherein the determination of the positions and orientations of these three sides comprises identifying the surface normals of these three sides and identifying the relative position of the common corner.

21. The method according to claim 16,
wherein the method comprises:
requesting and/or entering the side lengths of the cuboid test object.

22. The method according to claim 16,
wherein the method further comprises:
conveying the cuboid test object in a third relative position and orientation through the detection zone of the at least one spatial sensor and recording and evaluating a third set of corresponding measurement data; and
wherein the third relative position and orientation differ from the first and the second relative position and orientation at least in terms of the horizontal orientation and/or horizontal position.

23. The method according to claim 22,
wherein the method further comprises:
conveying the cuboid test object in a fourth relative position and orientation through the detection zone of the at least one spatial sensor and recording a fourth set of corresponding measurement data by means of the at least one spatial sensor and the at least one speed sensor;
wherein an absolute position of the at least one spatial sensor relative to a fixed origin is determined on the basis of the totality of the four sets of measurement data, taking into account the reference data, using a mathematical optimization algorithm.

24. The method according to claim 16,
wherein the optimization algorithm uses an affine transformation and/or represents a rotation by quaternions.

25. The method according to claim 16,
wherein the optimization algorithm solves an optimization problem, wherein the optimization problem comprises a minimization problem that is solved iteratively.

26. The method according to claim 16,
wherein the positions and orientations of the different measurement sequences of the test object through the detection zone each differ from one another by at least two of the horizontal orientation, the vertical orientation and the horizontal positioning.

27. The method according to claim 16,
wherein the vertical positioning of the cuboid test object is defined by a conveying surface of the conveying device, on which conveying surface one side of the cuboid test object lies, and is identical for all the measurement sequences.

28. The method according to claim 16,
wherein the method further comprises:
positioning the cuboid test object in the detection zone of the at least one spatial sensor and recording associated static measurement data;
determining the relative position of the at least one spatial sensor relative to at least one further sensor; and
determining an absolute position of the at least one further sensor from the determined relative position of the at least one further sensor relative to the at least one spatial sensor.

29. A sensor system, that is configured to carry out a method for calibrating the sensor system, the sensor system comprising at least one spatial sensor and at least one speed sensor for conveying devices, wherein the method comprises at least the following steps:
recording reference data with an empty detection zone of the spatial sensor by means of the at least one spatial sensor;
conveying a cuboid test object in a first relative position and orientation through the detection zone of the at least one spatial sensor and recording a first set of corresponding measurement data by means of the at least one spatial sensor and the at least one speed sensor;
conveying the cuboid test object in a second relative position and orientation through the detection zone of the at least one spatial sensor and recording a second set of corresponding measurement data by means of the at least one spatial sensor and the at least one speed sensor;
determining the different positions and orientations of at least three sides of the test object relative to the at least one spatial sensor using the two sets of measurement data against the background of the reference data;
determining a relative orientation of the at least one spatial sensor relative to said three sides of the cuboid test object;
determining an absolute orientation of the at least one spatial sensor and/or a correspondence factor for the speed sensor based on the determined positions and orientations of the at least three sides of the test object from the at least two measurement sequences using a mathematical optimization algorithm.

30. A conveying system comprising a conveying device for conveying objects and a sensor system according to claim 29, said sensor system being oriented to the conveying device and being configured to analyze objects that are conveyed by the conveying device.

31. The method according to claim 17,
wherein the detection zones of said spatial sensors intersect and/or overlap one another.

32. The method according to claim 20,
wherein the common corner referred to lies above a conveying plane spanned by the conveying surface.

33. The method according to claim 22,
wherein the vertical orientation of all three relative positions and orientations are different from one another and the method comprises determining and/or correcting the side lengths of the cuboid test object using the three sets of measurement data for the three different vertical orientations of the cuboid test object.

34. The method according to claim 26,
wherein the positions and orientations of the different measurement sequences of the test object through the detection zone each differ from one another by exactly two of the horizontal orientation, the vertical orientation and the horizontal positioning.

35. The method according to claim 28,
wherein the at least one further sensor is one of a reading device, a camera and another type of trigger sensor.

36. The sensor system according to claim 29 that is a volume measurement system.
